(19) United States
(12) Patent Application Publication
(10) Pub. No.: US 2015/0134522 A1
(43) Pub. Date: May 14, 2015

(54) ENHANCED AUTHORIZATION MESSAGE METHOD AND APPARATUS

(71) Applicant: MASTERCARD INTERNATIONAL INCORPORATED, Purchase, NY (US)

(72) Inventors: James Carrington, Greenwich, CT (US); Matthew Sordi, Sandy Hook, CT (US); Paul Chang, Fort Lee, NJ (US)

(73) Assignee: MASTERCARD INTERNATIONAL INCORPORATED, Purchase, NY (US)

(21) Appl. No.: 14/076,036

(22) Filed: Nov. 8, 2013

(51) Int. Cl. G06Q 20/40

(52) U.S. Cl. CPC G06Q 20/40
USPC 705/44

(57) ABSTRACT

A system, apparatus, and computer-readable storage medium configured to indicate an elevated status of a customer via an enhanced authorization message.

### BACKGROUND

1. Field of the Disclosure

Aspects of the disclosure relate in general to financial services. Aspects include an apparatus, system, method and computer-readable storage medium to indicate an elevated status of a customer via an enhanced authorization message.

2. Description of the Related Art

Traditionally the high-end retail, hospitality, travel and entertainment industries spend a lot of time, effort and money to attract repeat business.

In the hospitality industry for example, hotel chains attempt to track and keep loyalty of their high-value customers by offering status, reward points and perks to their frequent guests. A hotel may offer early check-in, discounts, meals, free Internet, or other perks to such guests.

However, a hotel chain may fail to recognize a potential high-value customer that frequents a competitor chain, and may consequently fail to obtain a valuable new repeat customer.

Similar problems exist in other “high touch” industries involving frequent customer interaction.

### SUMMARY

Embodiments include a system, device, method and computer-readable medium configured to indicate an elevated status of a customer via an enhanced authorization message.

A payment network comprises a network interface and a microprocessor. A network interface is configured to receive from an acquirer a financial transaction request. The financial transaction request includes a customer Primary Account Number and a transaction amount. A microprocessor is configured to determine whether a customer associated with the customer Primary Account Number has been designated for elevated status. The network interface is further configured to electronically transmit a financial transaction approval message when an issuer has approved the financial transaction request, the customer associated with the customer Primary Account Number has been designated for elevated status. The financial transaction approval message containing a designation of elevated status.

### BRIEF DESCRIPTION OF THE DRAWINGS

FIG. 1 illustrates an embodiment of a system configured to indicate an elevated status of a customer via an enhanced authorization message.

FIG. 2 is a block diagram of a payment network embodiment configured to indicate an elevated status of a customer via an enhanced authorization message.

FIG. 3 illustrates a flowchart of a method embodiment to indicate an elevated status of a customer via an enhanced authorization message.

### DETAILED DESCRIPTION

One aspect of the disclosure includes the realization that payment networks are uniquely qualified to identify potential high-value (“very important person” or “VIP”) customers based on the customer/cardholder's spending patterns.

A further aspect of the disclosure includes the understanding that the high-end retail, hospitality, travel and entertainment industries could take advantage of knowledge potential VIP or high-value customers to expand their business by providing “surprise and delight” services to high valued cardholders.

Another aspect of the disclosure includes identifying customers of high (elevated) status, and informing high-end retail, hospitality, travel and/or entertainment provider of the customer status via an enhanced authorization message when a financial transaction is taking place.

Embodiments of the present disclosure include a system, method, and computer-readable storage medium configured to indicate an elevated status of a customer via an enhanced authorization message.

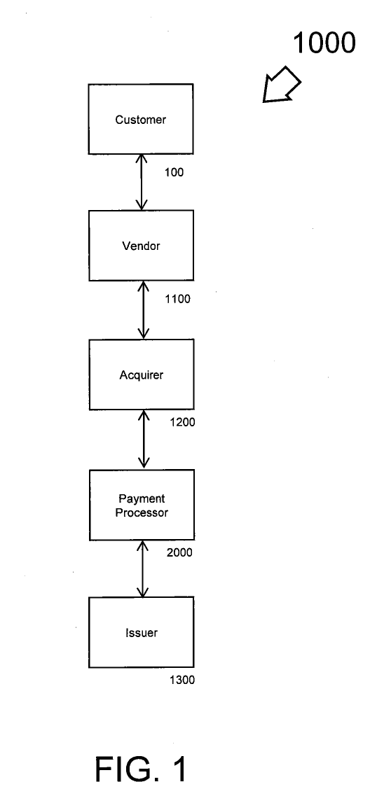

FIG. 1 illustrates an embodiment of a system 1000 configured to indicate an elevated status of a customer 100 via an enhanced authorization message, constructed and operative in accordance with an embodiment of the present disclosure.

In system 1000, a customer 100 engages in a financial transaction with a vendor 1100 in the high-end retail, hospitality, travel or entertainment industries using a payment card. During one example transaction, the vendor 1100 communicates with an acquirer 1200, which contacts payment network 2000. In turn, payment network 2000, contacts issuer 1300 to verify that the customer 100 has the credit or available funds to engage in the financial transaction. When the issuer 1300 approves the transaction, the issuer 1300 or payment processor 2000 may flag an elevated status of the customer/cardholder 100. The vendor 1100 receives the transaction approval along with an indicator of the customer/cardholder's elevated status. The vendor 1100 may then use the elevated status information to “surprise and delight” the cardholder 100.

In system 1000, a customer 100 is a cardholder of a payment card. Consequently, the disclosure uses the term customer and cardholder interchangeably. A payment card may be any credit, debit, automated teller-machine, charge, stored-value card, or the like that can be used by a cardholder and accepted by a merchant/vendor 1100 to make a payment for a purchase or in payment of some other obligation. More significantly, for purposes of this disclosure, payment cards also include any electronic payment device, including but not limited to: key-fobs, mobile phones, electronic wallets, cloud-based payment device, or other payment device known in the art. Often, payment cards are branded by a payment network 2000, such as MasterCard™, a trademark of MasterCard International Incorporated of Purchase, New York.

Vendor 1100 may be any provider of goods or services. The disclosure assumes that the vendor 1100 is a location with customer service representatives that can receive the indicator of elevated cardholder status, such as the high-end retail, hospitality, travel or entertainment industries. It is understood that other industries may be equally applicable. In various embodiments, vendor 1100 offers products or services that may be paid with a payment card.

Acquirer 1200 is a financial institution, such as a bank or credit union, which is affiliated with vendor 1100. Acquirer 1200 assists and serves as the financial institution for vendor 1100. Acquirer 1200 is configured to process data from the vendor 1100 and prepares the authorization-formatted data for the payment network 2000, usually sent directly to an issuer 1300.

Payment network 2000 is a payment network capable of processing payments electronically. An example payment network 2000 includes MasterCard International Incorporated. The payment network 2000 includes the set of API functions, processes, and data that allow a customer 100 to pay a vendor 1100, to ensure the proper payment format is produced and the payment is sent to the correct financial entity. Payment network 2000 produces a format to ensure payment information is processed according to the Payment Card Industry Data Security Standard (PCI DSS) and financial industry standards. The Payment Card Industry Data Security Standard (PCI DSS) is a set of requirements designed to ensure that companies that process, store or transmit credit card information maintain a secure environment.

An issuer 1300 is the financial institution that provides the credit for the payment transaction. Issuer bank 1300 processes data (authorization requests) from the acquirer 1200 and prepares the authorization-formatted response (approvals/declines).

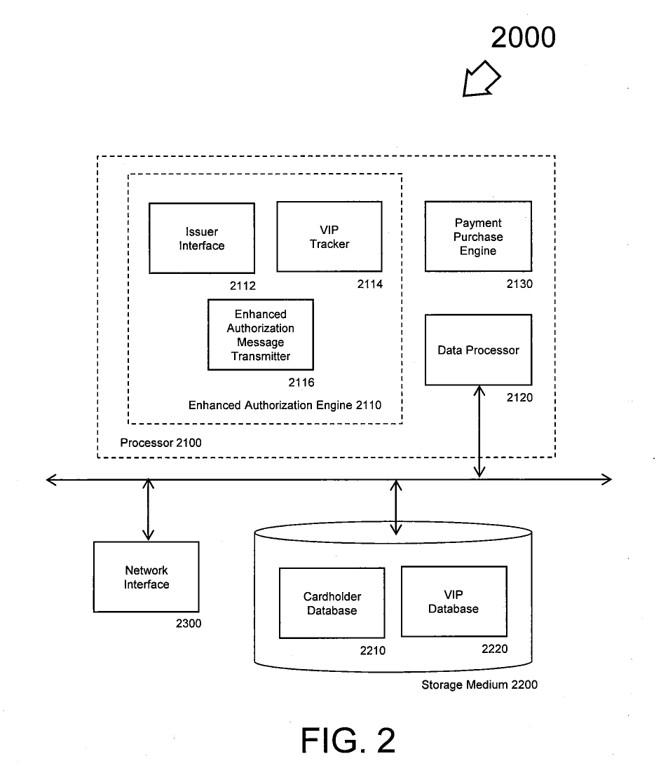

Embodiments will now be disclosed with reference to a block diagram of an exemplary payment network server 2000 of FIG. 2, constructed and operative in accordance with an embodiment of the present disclosure. In this embodiment, payment network server 2000 is configured to indicate an elevated status of a customer via an enhanced authorization message.

When a financial transaction takes place at a vendor 1100, the payment network server 2000 embodiment may evaluate the status level of a cardholder 100. In some instances, the elevated cardholder status may be set by issuer 1300. Elevated cardholder status may be determined in a myriad of ways. Elevated cardholder status may be determined by: overall spend-level of the cardholder 100, frequency of cardholder spend at a particular type of vendor or merchant classification, frequency of travel, self-reported elite status memberships, or any combination thereof.

In alternate embodiments, elevated cardholder status may be predetermined based on any of the above factors.

Payment network server 2000 may run a multi-tasking operating system (OS) and include at least one processor or central processing unit (CPU) 3100, a non-transitory computer-readable storage medium 2200, and a network interface 2300. An example operating system may include Advanced Interactive Executive (AIX™) operating system, UNIX operating system, or LINUX operating system, and the like.

Processor 2100 may be any central processing unit, microprocessor, micro-controller, computational device or circuit known in the art. It is understood that processor 2100 may temporarily store instructions and data in Random Access Memory (not shown).

As shown in FIG. 2, processor 2100 is functionally comprised of an enhanced authorization engine 2110, a payment-purchase engine 2130, and a data processor 2120.

Enhanced authorization engine 2110 may further comprise: issuer interface 2112, VIP tracker 2114, and enhanced authorization message transmitter 2116.

Issuer interface 2112 is an application program interface (API) or other interface known in the art to receive and process information from an issuer 1300. In some embodiments, issuer interface 2112 receives elevated status information from an issuer 1300.

VIP tracker 2114 is the portion of the enhanced authorization engine 2110 that determines an elevated status level of a cardholder 100. As discussed above, the elevated status may be determined from the amount or type of cardholder spending. In other embodiments, elevated status level may be determined by dynamic spend bands by market and product that determine optimal spend targets. In other embodiments, the elevated status level is determined by an issuer 1300.

Enhanced authorization message transmitter 2116 structures and formats an enhanced authorization message for payment-purchase engine 2130. In some embodiments, an enhanced authorization message is virtually identical to a standard authorization message, but contains an additional (1-bit) flag, which indicates that the customer is has elevated status.

Payment-purchase engine 2130 performs payment and purchase transactions, and may do so in conjunction with the enhanced authorization method described herein.

Data processor 2120 enables processor 2100 to interface with storage medium 2200, network interface 2300 or any other component not on the processor 2100. The data processor 2120 enables processor 2100 to locate data on, read data from, and write data to these components.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with vendors 1100, acquirer 1200, and/or issuer 1300.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a cardholder database 2210, and VIP database 2220. Cardholder database 2210 facilitates the look-up of issuers 1300 and cardholder information. VIP database 2220 is a database storing Primary Account Numbers of payment cards of cardholders with elevated status.

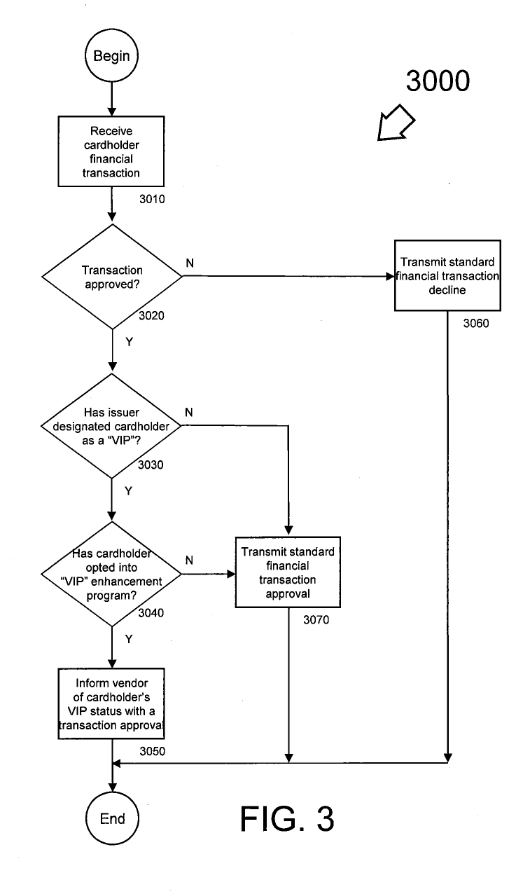

It is understood by those familiar with the art that one or more of these databases 2210-2220 may be combined in a myriad of combinations. The function of these structures may best be understood with respect to the flowchart of FIG. 3, as described below.

We now turn our attention to method or process embodiment of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 illustrates a flowchart of a method embodiment 3000 to indicate an elevated status of a customer via an enhanced authorization message, constructed and operative in accordance with an embodiment of the present disclosure. Method 3000 occurs at payment network 2000, and is executed by a payment network server.

It is assumed that that cardholders opt-into an enhanced authorization program. The opt-in may occur via any opt-in method known in the art. Depending upon the implementation, the opt-in data may be stored in cardholder database 2210, VIP database 2220, or both.

Initially, a network interface 2300 receives a cardholder financial transaction authorization request from a vendor 1100 or acquirer 1200, block 3010. Note that the authorization request is a real-time (non-clearing) process. The financial transaction authorization request includes a primary account number of the payment card used, an identifier for the vendor 1100, and an amount of the financial transaction (“transaction information”).

The payment-purchase engine 2130 determines the issuer 1300 that issued the payment card (based on the primary account number) and forwards the authorization request to the issuer 1300.

If the issuer approves the transaction at block 3020, process 300 continues at block 3030.

If the issuer does not approve the transaction at block 3020, a standard financial transaction decline message is sent to the vendor 1100 or acquirer 1200, block 3060. Process 3000 then ends.

At block 3030, VIP tracker 2114 checks the VIP database 2220 to determine whether the issuer has designated the cardholder 100 as a “very important person” for elevated status. If the cardholder 100 has not been designated for elevated status, a standard financial transaction approval is transmitted at block 3070. If the cardholder 100 has been designated for elevated status, the process continues at block 3040.

At block 3040, VIP tracker 2114 checks the cardholder database 2210 to determine whether the cardholder 100 has opted into the elevated status program. If the cardholder 100 has not opted-in, a standard financial transaction approval is transmitted at block 3070. If the cardholder 100 has opted-in, the process continues at block 3050.

At block 3050, enhanced authorization message transmitter 2116 structures and formats an enhanced authorization message for payment-purchase engine 2130, which is transmitted to vendor 1100 or acquirer 1200 via network interface 2300. In some embodiments, an enhanced authorization message is virtually identical to a standard authorization message, but contains an additional (1-bit) flag (“VIP data flag”), which indicates that the customer is has elevated status.

The vendor 1100 will receive the flag, and an indicator will be displayed on a customer service representative's screen indicating the elevated status. In one embodiment, the point-of-sale device receives the enhanced authorization message, which includes the VIP data flag; upon reading that the flag is set to VIP, the point-of-sale device retrieves a message from a data storage device and displays this on the screen. The customer service representative may then reward the cardholder 100 with an appropriate “surprise and delight” upgrade or other reward.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A payment network method comprising:
receiving at the payment network, from an acquirer via a network interface, a financial transaction request, the financial transaction request including a customer Account Number and a transaction amount;
determining, with a microprocessor, whether a customer associated with the customer Account Number has been designated for elevated status;
transmitting, via the network interface, a financial transaction approval message when an issuer has approved the financial transaction request and the customer associated with the customer Account Number has been designated for elevated status, the financial transaction approval message containing a designation of elevated status.

2. The method of claim 1 further comprising:
checking whether the customer has opted-in for elevated status.

3. The method of claim 2 further comprising:
wherein the designation of elevated status is forwarded by the acquirer to a vendor, and the designation of elevated status is displayed at the vendor.

4. The method of claim 3 wherein the elevated status for the customer is determined based on a customer spending pattern.

5. The method of claim 3 wherein the elevated status for the customer is determined based on an overall spend-level of the customer.

6. The method of claim 3 wherein the elevated status for the customer is determined based on frequency of cardholder spend at a particular type of vendor.

7. The method of claim 1 wherein the customer Account Number is a payment card Primary Account Number.

8. A payment network apparatus comprising:
a network interface configured to receive from an acquirer a financial transaction request, the financial transaction request including a customer Account Number and a transaction amount;
a microprocessor configured to determine whether a customer associated with the customer Account Number has been designated for elevated status;
wherein the network interface is further configured to electronically transmit a financial transaction approval message when an issuer has approved the financial transaction request and the customer associated with the customer Account Number has been designated for elevated status, the financial transaction approval message containing a designation of elevated status.

9. The apparatus of claim 8 wherein the microprocessor is further configured to check whether the customer has opted-in for elevated status.

10. The apparatus of claim 9 further comprising:
wherein the designation of elevated status is forwarded by the acquirer to a vendor, and the designation of elevated status is displayed at the vendor.

11. The apparatus of claim 10 wherein the elevated status for the customer is determined based on a customer spending pattern.

12. The apparatus of claim 10 wherein the elevated status for the customer is determined based on an overall spend-level of the customer.

13. The apparatus of claim 10 wherein the elevated status for the customer is determined based on frequency of cardholder spend at a particular type of vendor.

14. The apparatus of claim 8 wherein the customer Account Number is a payment card Primary Account Number.

15. A non-transitory computer readable medium encoded with data and instructions, when executed by a computing device the instructions causing the computing device to:
receive at the payment network, from an acquirer via a network interface, a financial transaction request, the financial transaction request including a customer Account Number and a transaction amount;
determine, with a microprocessor, whether a customer associated with the customer Account Number has been designated for elevated status;
transmit, via the network interface, a financial transaction approval message when an issuer has approved the financial transaction request and the customer associated with the customer Account Number has been designated for elevated status, the financial transaction approval message containing a designation of elevated status.

16. The non-transitory computer readable medium of claim 15, the instructions further causing the computing device to:
check whether the customer has opted-in for elevated status.

17. The non-transitory computer readable medium of claim 16 further comprising:
wherein the designation of elevated status is forwarded by the acquirer to a vendor, and the designation of elevated status is displayed at the vendor.

18. The non-transitory computer readable medium of claim 17 wherein the elevated status for the customer is determined based on a customer spending pattern.

19. The non-transitory computer readable medium of claim 17 wherein the elevated status for the customer is determined based on an overall spend-level of the customer.

20. The non-transitory computer readable medium of claim 17 wherein the elevated status for the customer is determined based on frequency of cardholder spend at a particular type of vendor.
